(19) United States
(12) Patent Application Publication
(10) Pub. No.: US 2024/0356603 A1
(43) Pub. Date: Oct. 24, 2024

(54) METHOD AND/OR DEVICE FOR REPORTING QUANTIZED VALUES FOR A CHANNEL STATE INFORMATION QUANTITY

(71) Applicant: Nokia Technologies Oy, Espoo (FI)

(72) Inventors: Roman KOVALCHUKOV, Espoo (FI); Filippo TOSATO, Massy (FR); Luis Alberto SUAREZ RIVERA, Munich (DE); Andrea BONFANTE, Massy (FR)

(21) Appl. No.: 18/636,992

(22) Filed: Apr. 16, 2024

Related U.S. Application Data
(60) Provisional application No. 63/460,446, filed on Apr. 19, 2023.

(51) Int. Cl. H04B 7/06; H04L 5/00

(52) U.S. Cl. CPC H04B 7/0626; H04B 7/0632; H04L 5/0051

(57) ABSTRACT

An apparatus or network entity may be configured to: determine at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; indicate, to a user equipment, the at least one quantization parameter; and receive, from the user equipment, one or more reports of at least one channel state information quantity based on the at least one quantization parameter indicated by the network entity to the user equipment.

### CROSS-REFERENCE TO RELATED APPLICATIONS

This application claims priority to, and the benefit of, U.S. provisional application No. 63/460,446 filed on 19 Apr. 2023, which is incorporated herein by reference in its entirety.

### TECHNICAL FIELD

The example and non-limiting embodiments relate generally to tracking of channel state information quantities and, more particularly, to the configuration of quantization tables associated with the channel state information quantities.

### BACKGROUND

It is known, in network communication, to construct a quantization table based on initial analysis.

### SUMMARY

The following summary is merely intended to be illustrative. The summary is not intended to limit the scope of the claims.

In accordance with one aspect, a network entity comprising: at least one processor; and at least one memory storing instructions that, when executed by the at least one processor, cause the network entity at least to: determine at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; indicate, to a user equipment, the at least one quantization parameter; and receive, from the user equipment, one or more reports of at least one channel state information quantity based on the at least one quantization parameter indicated by the network entity to the user equipment.

In accordance with one aspect, a method comprising: determining at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; indicating, to a user equipment, the at least one quantization parameter; and receiving, from the user equipment, one or more reports of at least one channel state information quantity based on the at least one quantization parameter indicated by the network entity to the user equipment.

In accordance with one aspect, an apparatus comprising means for performing: determining at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; indicating, to a user equipment, the at least one quantization parameter; and receiving, from the user equipment, one or more reports of at least one channel state information quantity based on the at least one quantization parameter indicated by the network entity to the user equipment.

In accordance with one aspect, a non-transitory computer-readable medium comprising program instructions stored thereon for performing at least the following: determining at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; causing indicating, to a user equipment, of the at least one quantization parameter; and causing receiving, from the user equipment, of one or more reports of at least one channel state information quantity based on the at least one quantization parameter indicated by the network entity to the user equipment.

In accordance with one aspect, a user equipment comprising: at least one processor; and at least one memory storing instructions that, when executed by the at least one processor, cause the user equipment at least to: receive, from a network entity, at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determine at least one quantized channel state information quantity based, at least partially, on the at least one quantization parameter; and transmit, to the network entity, one or more reports of the at least one quantized channel state information quantity.

In accordance with one aspect, a method comprising: receiving, with a user equipment from a network entity, at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determining at least one quantized channel state information quantity based, at least partially, on the at least one quantization parameter; and transmitting, to the network entity, one or more reports of the at least one quantized channel state information quantity.

In accordance with one aspect, an apparatus comprising means for performing: receiving, from a network entity, at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determining at least one quantized channel state information quantity based, at least partially, on the at least one quantization parameter; and transmitting, to the network entity, one or more reports of the at least one quantized channel state information quantity.

In accordance with one aspect, a non-transitory computer-readable medium comprising program instructions stored thereon for performing at least the following: causing receiving, from a network entity, of at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determining at least one quantized channel state information quantity based, at least partially, on the at least one quantization parameter; and causing transmitting, to the network entity, of one or more reports of the at least one quantized channel state information quantity.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a diagram illustrating features as described herein;

FIG. 5 is a diagram illustrating features as described herein;

FIG. 6A is a diagram illustrating features as described herein;

FIG. 6B is a diagram illustrating features as described herein;

FIG. 7 is a diagram illustrating features as described herein;

FIG. 8 is a diagram illustrating features as described herein;

FIG. 9 is a diagram illustrating features as described herein;

FIG. 10 is a flowchart illustrating steps as described herein; and

FIG. 11 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
AMF access and mobility management function
BS base station
CQI channel quality indicator
CRAN cloud radio access network
CSI channel state information
CSI-RS channel state information reference signal
CU central unit
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
I/F interface
L1 layer 1
LTE long term evolution
MAC medium access control
MIMO multiple input/multiple output
MME mobility management entity
MU-MIMO multiple user multiple input/multiple output
ng or NG new generation
ng-eNB or NG-eNB new generation eNB
NR new radio
N/W or NW network
O-RAN open radio access network
PDCP packet data convergence protocol
PHY physical layer
PMI precoding matrix indicator
RAN radio access network
RF radio frequency
RLC radio link control
RRC radio resource control
RRH remote radio head
RS reference signal
RU radio unit
Rx receiver
SDAP service data adaptation protocol
SGW serving gateway
SMF session management function
SRS sounding reference signal
SU-MIMO single user multiple input/multiple output
TDCP time domain channel properties
TRP transmission/reception point
TRS tracking CSI-RS (a.k.a. tracking reference signal)
Tx transmitter
UE user equipment (e.g., a wireless, typically mobile device)
UPF user plane function
VNR virtualized network function

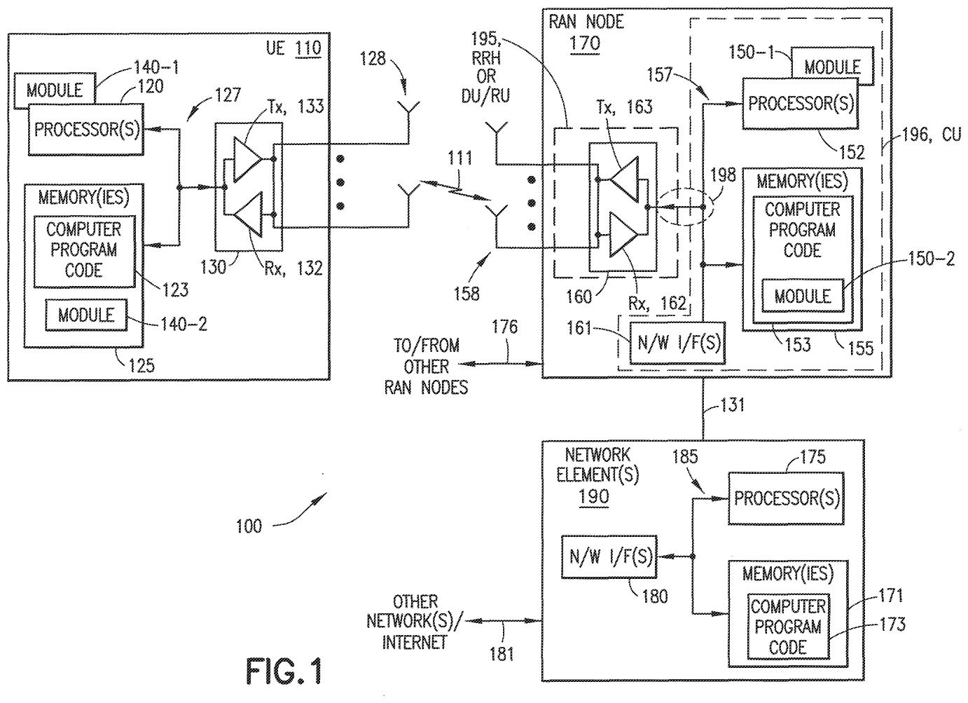

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a network entity, typically a base station or a set of base stations jointly cooperating, also known as transmission/reception points (TRP) that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein may generally relate to time domain channel properties (TDCP). For Rel 18 CSI enhancements, a new channel state information (CSI) quantity, TDCP, has been presented into the 3GPP industrial community. The function of the TDCP indicator is focused to provide the base station (BS) radio physical interface with new CSI information regarding the relative mobility of the UE, and associated Doppler characteristics of the link with the serving BS. This indicator is useful for specific reconfiguration uses cases, like CSI codebook type switching and reference signal reconfiguration (e.g., SRS).

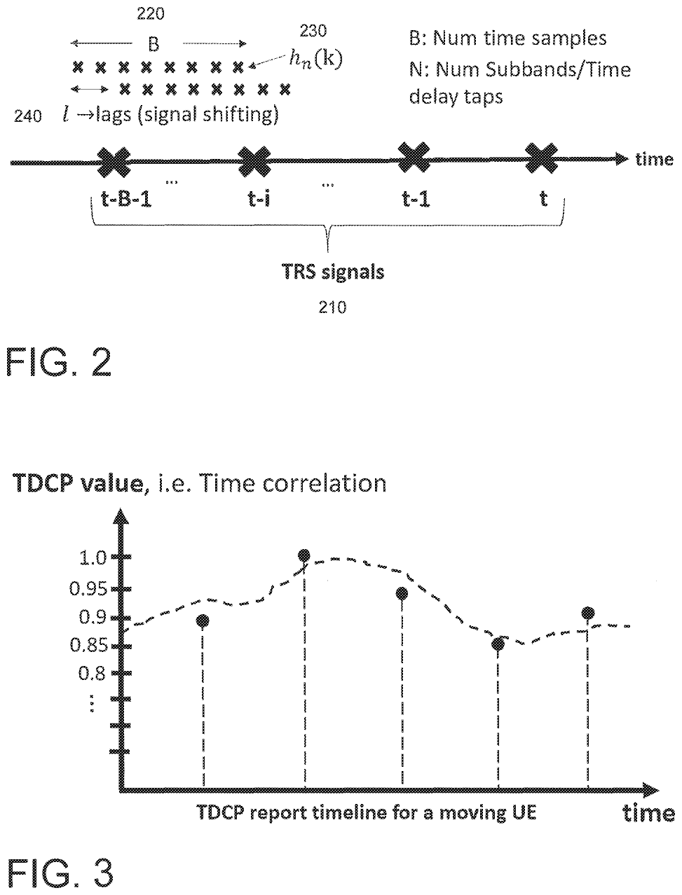

The Doppler spectrum is defined as the Fourier transform of the time-correlation function of the channel. Let hₙ(k) be the tracking reference signal (TRS) channel measured at subcarrier n, with n=0, . . . , N−1, and time kTₛ, where Tₛ is the time interval between two consecutive TRS measurement occasions. Let us assume a UE takes B such TRS measurements at time k₀Tₛ, (k₀+1) Tₛ, . . . , (k₀+B−1)Tₛ. The normalized wideband time-correlation function (see, e.g., R1-2212169: Nokia/Nokia Shanghai Bell, 3GPP TSG RAN WG1 Meeting #111, Agenda item 9.1.2: CSI enhancement for high/medium UE velocities and CJT. November 2022) at lag ITₛ, averaged over the N subcarriers, is given by A(l) and described by Eq 1 and Eq 2. An illustration of the process is provided in FIG. 2.

$$A ( l ) = \frac{c ( l )}{c ( 0 )} \qquad Eq 1$$

$$c ( l ) = \frac{1}{N} {\sum }_{n = 0}^{N - 1} \frac{1}{B - l} {\sum }_{k = {k}_{0}}^{{k}_{0} + B - 1 - l} {h}_{n} ( k + l ) {h}_{n}^{*} ( k ) , \qquad Eq 2$$

$$l = 0 , … , B - 1$$

It may be noted that h*ₙ(k) means the conjugate transpose of hₙ(k).

In the present disclosure, a “time domain channel properties” may also be referred to as a “time correlation function” or a “time-domain correlation profile” or a “time-domain correlation” or a “normalized wideband time-correlation function” or a “time correlation” or an “amplitude” or a “time-domain correlation function”.

Referring now to FIG. 2, illustrated is an example of the time correlation calculation for TDCP. The TRS signals (210) may be measured at occasions t−B−1, t−i, t−1, and t. A UE may take B TRS measurements (220) of the TRS channel hₙ(k) (230). During correlation calculation in Eq. 2, the signal may shift, as illustrated by the lag l (240).

In RAN1 #112 meeting, alternative B. Time domain correlation profile was selected as the TDCP value out of a set of other alternatives. The time domain correlation profile is described in TABLE 1:

TABLE 1

| | |
|---|---|
| B. Time-domain correlation profile | Normalized auto-correlation of a time series measured |
| Non-zero quantized version of | from a TRS resource. |
| amplitude A(t, τ) for a number of | Multiple auto-correlation values can be calculated from |
| delay values τ (quantized amplitude | different lags of the same resource or different resources |
| vs delay) | The autocorrelation can be estimated by replacing the |
| Example equation | channel hₙ for subcarrier n in the defining formula in |
| $A ( t , τ ) = \vert \frac{c ( t , τ )}{c ( t , 0 )} \vert$ | column 2, with the matched filter subcarrier components Xₙ = Rₙ · S*ₙ of the received signal Rₙ |
| where | where S*ₙ is the complex conjugate of the known |
| $c ( t , τ ) = {\sum }_{n = 0}^{N - 1} {h}_{n} ( t + τ ) \cdot {h}_{n}^{*} ( t )$ | transmitted TRS signal. For c(t, 0) one can use the arithmetic average over the two TRS symbols separated by the time τ, i.e. |
| and hₙ is the channel for subcarrier n. | $A ( t , τ ) \approx \frac{\vert {\sum }_{n = 0}^{N - 1} {X}_{n} ( t + τ ) \cdot {X}_{n}^{*} ( t ) \vert}{\frac{1}{2} \cdot {\sum }_{n = 0}^{N - 1} ( {X}_{n} ( t ) \cdot {X}_{n}^{*} ( t ) + {X}_{n} ( t + τ ) \cdot {X}_{n}^{*} ( t + τ ) )}$ |
| | Or, alternatively, one may use the geometric average |
| | for c(t, 0), i.e. |
| | $A ( t , τ ) \approx \frac{\vert {\sum }_{n = 0}^{N - 1} {X}_{n} ( t + τ ) \cdot {X}_{n}^{*} ( t ) \vert}{\sqrt{{\sum }_{n} {\vert {X}_{n} ( t + τ ) \vert}^{2}} \sqrt{{\sum }_{n} {\vert {X}_{n} ( t ) \vert}^{2}}}$ |
| | Further methods to remove noise bias and to suppress |
| | noise can be used. |

In the latest round of discussions for RAN1 #112 meeting, the TDCP concept has been almost defined entirely as a new technical item to be introduced in the standard. These were the additional agreements:
“ . . . The number of lags Y=1 was chosen as a default feature with delay ≤D_{basic} symbols, only wideband quantized normalized amplitude is reported.
The optional feature, Y=1 with delay >D_{basic} symbols and Y≥1, wideband quantized normalized amplitude and (optionally) phase for each delay are reported . . . ”

D_{basic} is a delay between two consecutive TRS channel measurements in symbols.

Given the dynamic nature of channel, TDCP might vary in time, and the value of TDCP may need to be tracked in time, as a UE is expected to have variable mobility characteristics. Moreover, for certain applications like codebook switching, an accurate reporting of TDCP value quantity is desired. A technical effect of example embodiments of the present disclosure may be to respond to such needs with adequate bit budget utilization.

In an example embodiment, adaptive quantization and reconfigurability features may be provided.

In an example embodiment, a reconfigurable quantization and reporting scheme may be provided for the TDCP CSI value quantity. However, a reconfigurable quantization and reporting scheme may be provided for other CSI quantities (e.g. channel quality indicator (CQI), some other cases of precoding matrix indicator (PMI) related values) as well by using an analogously the same scheme proposed in this document.

Features as described herein may generally relate to quantization and reporting of TDCP quantities. Details about how the TDCP quantities are quantized and reported may be thoroughly discussed in the following 3GPP meetings for finalizing Rel 18 definition.

Quantization may involve a partitioning scheme, for example a partitioning schemes based on logarithmic and/or linear scale. For example, fixed logarithmic quantization can be found in specification TS 38.214 (see, e.g., 3GPP TS 38.214 V17.5.0 (2023-03) 3rd Generation Partnership Project; Technical Specification Group Radio Access Network; Physical layer procedures for data (Release 17)) for the CSI procedures to calculate amplitudes of the W2 coefficients for Type II and Enhanced Type II PMI report. There exists also state of the art algorithms like Huffman coding schemes (see, e.g., D. A. Huffman, “A Method for the Construction of Minimum-Redundancy Codes,” in Proceedings of the IRE, vol. 40, no. 9, September 1952) and Lloyd's algorithm (see, e.g., S. Lloyd, “Least squares quantization in PCM,” in IEEE Transactions on Information Theory, vol. 28, no. 2, March 1982), which are useful for having adaptive quantization partitioning and bit coding in a diversity of computer science domains.

Example embodiments of the present disclosure may relate to key parametrization values, and/or the reconfiguration capabilities necessary for being able to report a CSI quantity or a set of CSI quantity values, and/or being able to reconfigure a quantization scheme distribution. Example embodiments of the present disclosure may not be limited to quantization of TDCP quantities, but rather may extend to other CSI quantities, such as CQI, or other specific CSI related quantities that might be defined in the future.

In an example embodiment, a mechanism for reporting TDCP quantities may be provided.

Features as described herein may generally relate to time domain channel correlation. Examples of time correlation calculation as a useful CSI quantity are presented in Uchida Ryosuke, Kimata Masayuki, Fading Doppler Frequency Estimation Device And Fading Doppler Frequency Estimation Method, US2015189617, April 2013; Jiang Jing, Zhang Li, Method And Device For Feeding Back Channel State Information, WO12152135, May 2012; and Zhang Ranran, Sun Guangyu, Wang Zhigang, Li Yan, Huang Qixin, Zhou Tong, Yang Xiaohui, Method And Device For Switching Transmission Methods In Massive MIMO System, US2022103211, September 2021. For instance, Ryosuke et al. focuses on obtaining the time correlation properties to derive the Doppler related information of the channel. In the same direction, the aim of Jing et al. is to use such a time correlation knowledge for CSI periodicity reconfiguration by inferring the time of correlation of channel. Ranran et al. presents other applications of the time correlation; the topic of transmission mode switching in Massive MIMO systems, (i.e. Type I/Type II codebook and/or SU/MU-MIMO mode switching) is specifically addressed.

Features as described herein may relate to reporting and quantization of CSI quantities, such as CQI and PMI. Grant Stephen J, Molnar Karl James, Wang Yi Pin Eric, Cheng Jung Fu, Krasny Leonid, Method And Apparatus For Generating Channel Quality Information For Wireless Communication, US2007275665, May 2006 presents a method of reporting channel quality conditions which comprehensively assesses channel conditions for reliable/non-reliable channel estimation scenarios. The quantization is mentioned, however is not studied in detail how to carry out this specific step. Moulsley Timothy James, Baker Matthew Peter John, Efficient CQI Signaling In Multi-Beam MIMO Systems, US20090310693, August 2007 proposes different CQI quantization granularities for different measured beam signals, which suggest that quantization tables may be selected at least from predetermined options. James et al. also proposes the utilization of thresholds for decision making for which selected beams to report out the CQI values. However, a specific scheme of quantization and parametrical reconfigurability is not mentioned. Similarly, Kim Jung Bin, Jung Dong Hyun, Method And Apparatus For Channel State Information Feedback In Communication System, US2022321250, August 2021 mentions the possibility of requesting for changing the CQI tables, however it is implicitly understood that quantization scales are not recomputed based on input parameters, but only fixed choices are considered. In Hui Dennis, Krasny Leonid, Adaptive Compression Of Channel Feedback Based On Second Order Channel Statistics, US2009016425, July 2007, an adaptive rate quantization for PMI/Channel information based on second order channel statistics is presented. Again, we understand that number of bits (i.e. resolution of PMI coefficients) might be changed based on the aforementioned statistics, however the mechanism of reconfiguration to adapt the quantization rule, the customized scale range, and other determining parameters to track closely the CSI quantity into an adequate neighbor region are not mentioned.

Features as described herein may generally relate to a UE reporting a time-correlation amplitude measured on CSI reference signals for tracking, i.e. TRS. There are two technical problems to solve in relation to a UE reporting a time-correlation amplitude measured based on TRS: (1) providing accurate amplitude quantization in a value range that depends on the measured correlation lag(s), the metric and threshold used by the gNB to make decisions on CSI reporting configurations, and/or CSI configuration parameters (e.g. determine switching between Type-I and Rel-16 cType-II codebooks, or to determine SRS periodicity for UL-SRS reciprocity-based precoding schemes) based on the reported quantity, etc.; and (2) configuring the quantizer with a small number of RRC parameter values obtained from a real-valued high resolution threshold.

In the present disclosure, a channel state information reference signal may also be referred to as a tracking reference signal and a tracking channel state information reference signal(s).

As mentioned before, the TDCP value quantization is an open topic into the 3GPP discussions; a quantization scheme has not yet been defined. A TDCP value quantization scheme may conform to the following three requirements: (1) being able to track the changes of the TDCP CSI quantities; (2) provide the most accurate value possible to make correct reporting of the TDCP CSI quantities; and (3) based on the reported TDCP value, the NW should be able to make efficient decisions on the UE configuration.

Referring now to FIG. 3, illustrated is an example of TDCP quantization and reporting. In the example of FIG. 3, a single TDCP correlation value reporting may be tracked in time for a given UE. FIG. 3 shows that, with good quantization resolution, reporting the TDCP CSI quantity may not be a problem. However, if a fixed quantization table is assumed, it may be possible to have some inconvenient shortcomings, as the quantization table is probably underutilized. In other words, if the table has very high resolution just a portion of the states in the table may be used, with unnecessary bit overhead or, if the table is insufficient it will give as a result a high quantization error. Moreover, for some specific applications, the table of states might require concentrating the resolution in a different region of the CSI quantity. Currently, the tables are being constructed based on current initial analysis from different companies.

In an example embodiment, a general method of quantizing TDCP CSI values may be provided. Reconfigurability capabilities may be enabled at the BS side, which may enable customization of the quantization value based, at least partially, on the CSI quantity behavior. This reconfigurable quantization feature may also be used for other CSI quantities, like CQI and other representative present and future PMI values.

Exemplary quantization methods of TDCP value A with fixed schemes are the following: (1) 10·log₁₀(1−A) with ranges [−21, −20, . . . , −7, −6] (4 bits), [−20, −19, . . . , −14, −13] (3 bits), [−21, −19, . . . , −9, −7] (3 bits); (2) linear quantization with different subranges in [0,1]; or (3) Reusing the quantization levels,

$$p ( i ) = \{ 1 - {2}^{\frac{- i}{S}} , i = 0 , 1 , … , {2}^{Q} - 1 \}$$

(where s is a quantizer step-size s=2 for 3 db step-size, s=4 for 1.5 dB step-size, s=8 for 0.75 dB step-size, and Q is a number of bits used for quantizing), from Rel16 Type-II amplitude:

$$1 - p ( 1 : 8 ) ( 3 bits ) ,$$

$$1 - {p ( 1 : 8 )}^{2} ( 3 bits ) ,$$

$$\{ 1 , {( \frac{1}{2} )}^{\frac{1}{4}} , {( \frac{1}{2} )}^{\frac{2}{4}} , … , {( \frac{1}{2} )}^{\frac{14}{4}} , 0 \} ( 4 bits ) ,$$

$$\{ {( \frac{1}{2} )}^{\frac{1}{4}} , {( \frac{1}{2} )}^{\frac{2}{4}} , … , {( \frac{1}{2} )}^{\frac{8}{4}} \} ( 3 bits ) .$$

A quantization step size may also be referred to as a quantization alphabet step-size, a size of a quantization level, or a step-size.

The problem with most of the quantization techniques is that they provide overly broad values. At the same time, a useful dynamic range can be around an arbitrary value (i.e. decision threshold). This threshold is usually close to 1 (i.e. maximal TDCP value, for example 0.98 or 0.995). It depends on different things, such as use case, number of measurements, number of reported values, and/or delay between the measured TRSs.

For example, in the use case of switching between Type-I and Type-II codebooks: a) for Y=1 and 1 ms delay, optimal threshold is equal to 0.992; b) for Y=1 and 5 ms delay, optimal threshold is equal to 0.98; c) for Y=1 and 20 ms delay, optimal threshold is equal to 0.92; and d) for Y=2 and 1 ms delay, optimal threshold is equal to 0.995.

If the threshold is well known by both sides (e.g. the UE and the gNodeB/base station), with a tolerable degree of accuracy, it may be enough to use 1 bit for reporting if the threshold is exceeded or not. At the same time, it may be necessary to report the quantity itself to inform about the CSI values and the further updates of this threshold, but for that we might need a certain number of bits, depending on the resolution we require to converge to an adequate value. Therefore, there is a trade-off between the accuracy of the reported CSI quantity, and the number of bits to be used, which might be adjusted in successive updates.

As already mentioned, based on the reported value, the network may make a decision with only two choices: A or B. Therefore, the UE may report with only one bit of information; if the TDCP value is smaller than a threshold, it may report bit ‘0’, and decision A may be made, or, if TDCP value is equal to or higher than a threshold, the UE may reports bit ‘1’ and behavior B may be chosen by the network. However, this is only possible by further iterations on the threshold update.

The opposite situation is the high quantization error that might appear during threshold convergence. For instance, the (closest) quantization level may be too “far away” from the real threshold. With classic “fixed” quantization approaches we may need a large number of bits for the quantizer. Specifically, for current approaches in the context of TDCP discussions, we may require reporting 5-8 bits. Instead, as noted above, we may adjust a quantizer level via further iterations and, if at some point the TDCP value is stable enough, report a single bit based on the measured TDCP value and threshold obtained from a number of reconfigurations.

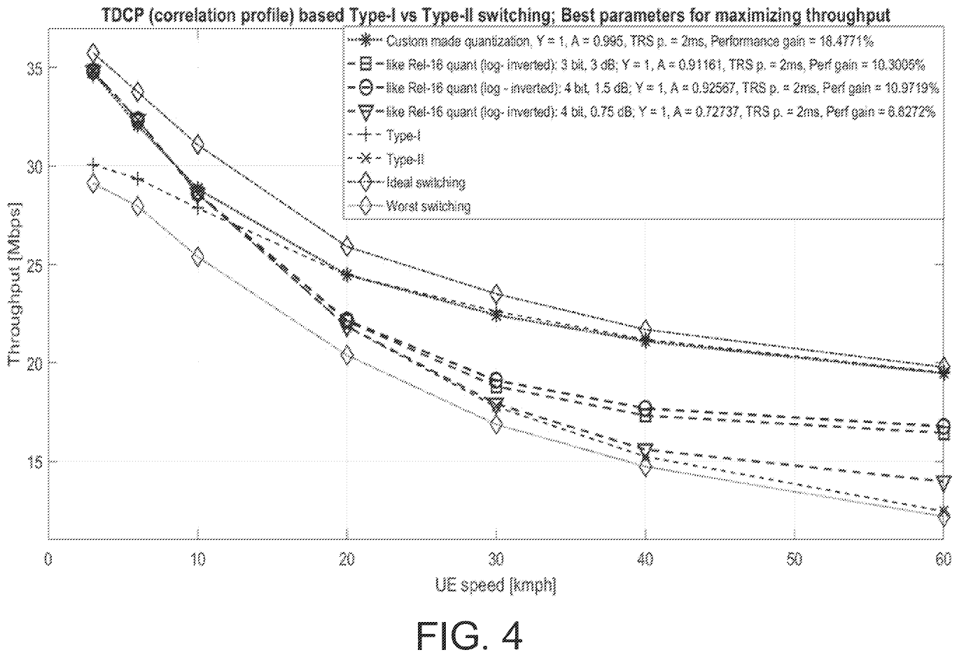

As a quantization scheme is degraded, up to a 12% performance drop may occur, in terms of average throughput. An example of the Type-I/Type II codebook switching with TDCP based thresholds is provided in FIG. 4. FIG. 4 provides a specific example based on the current use case of TDCP quantity value applied in a very particular situation for different measurement parameters. The aforementioned example shows an application of TDCP utilization which shows how quantization plays a major role. However the applicability of the concept of reconfigurability of quantization schemes for CSI quantities may cover a vast range of applications and may also be applied to other CSI quantities (e.g. CQI) and also future CSI quantities to be introduced in future releases.

In an example embodiment, a mechanism of quantization, reporting, and reconfigurability for a single CSI quantity or a set of CSI quantities may be provided. In an example embodiment, a type of the CSI quantity(ies) may be TDCP values or other classic CSI quantities, such as CQI.

In an example embodiment, a (same) quantization table may be reconfigurable. In an example embodiment, the quantization table may be reconfigured based, at least partially, on parametrization. In an example embodiment, the UE may report CSI quantities and then, based on the characteristics and distribution of the initial reported CSI quantities values, the BS may be capable of providing a reconfiguration setup, and may transmit a set of parameters to the UE to redefine the quantization table and adapt it to a specific neighboring region around a reference. In an example embodiment, the quantization table may be customized based on accurate tracking over time.

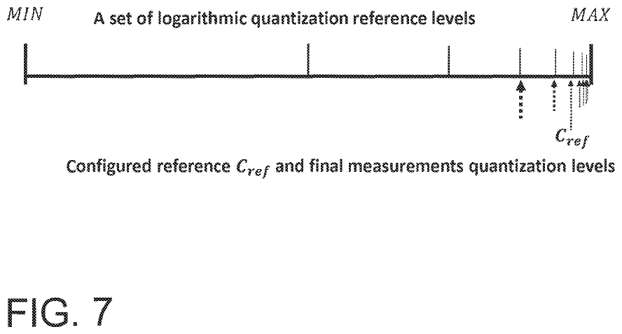

In an example embodiment, a base station or gNB may configure a CSI report, which may include one or more parameters to control a quantization alphabet used in the CSI report calculation. The quantization alphabet may be a chosen set of quantization levels that are used to define what bitstring values may be reported instead of an actual measurement. In an example embodiment, the one or more (configurable) parameters may control one or more of the quantization step-size(S), the maximum number of quantization levels (N) (which may determine a maximum quantization range value), and/or the alphabet size (Q) restricting the quantization range interval. The initial nominal quantization range interval may correspond to the maximum possible range shown in FIG. 7.

In the present disclosure, a “quantized channel state information measurement” might also be referred to as a “quantized channel state information measurement result”.

In an example embodiment, any three values of the set of minimum quantization range value (Nₘᵢₙ), maximum quantization range value (Nₘₐₓ), step-size(S), and alphabet bitsize (Q), which may be used to deduce the fourth value and fully parameterize the quantization table.

In an example embodiment, the one or more (configurable) parameters may include a reference offset C_{ref} with respect to a specified set of quantization levels. The reference offset may be considered the average value of the CSI quantity. However, average CSI quantity is just an example. In general, the value of highest importance (i.e. the decision threshold) may be anywhere in the range of possible measurements. Usually, we would want to have threshold C_{ref} somewhere closer to the middle of the quantization alphabet (see, e.g., FIG. 7, where arrows represent the configured quantization alphabet, and C_{ref} is one of these levels).

The parameter notation N, Q and S, as well as the possibility of configuration of a “fixed” threshold, were already mentioned in 3GPP offline discussions (PRE-offline Meeting #112bis). However, nothing so far has been discussed about the details of having a reconfigurable threshold, and the capability of jointly re-configuring the values of N, Q, S to respond to changes on the dynamic range of the CSI quantity or the capability to be able to converge to a stable quantization parameter setup. It is clear that, a fixed setup might not optimally work, as channel properties are variable in time, and real deployment and/or system characteristics may differ of what is observed in pre-defined models or simulation environments. Moreover, the process itself of control messaging exchange and the details on how the quantization parameters might be iterated in time to accurately quantize a neighboring region and the subset of quantization values is yet to be defined.

In an example embodiment, a UE may receive a CSI report configuration, which may include one or more parameters to control a quantization alphabet used in the CSI report calculation. In an example embodiment, the CSI report calculation may include calculation of time-domain correlation between two or more CSI reference signals for tracking (i.e. TRS). In an example embodiment, the UE may calculate the set of quantization levels from the CSI report setting configuration parameters. In an example embodiment, the amplitude of one or more time-correlation values may be quantized using the obtained set of quantization levels.

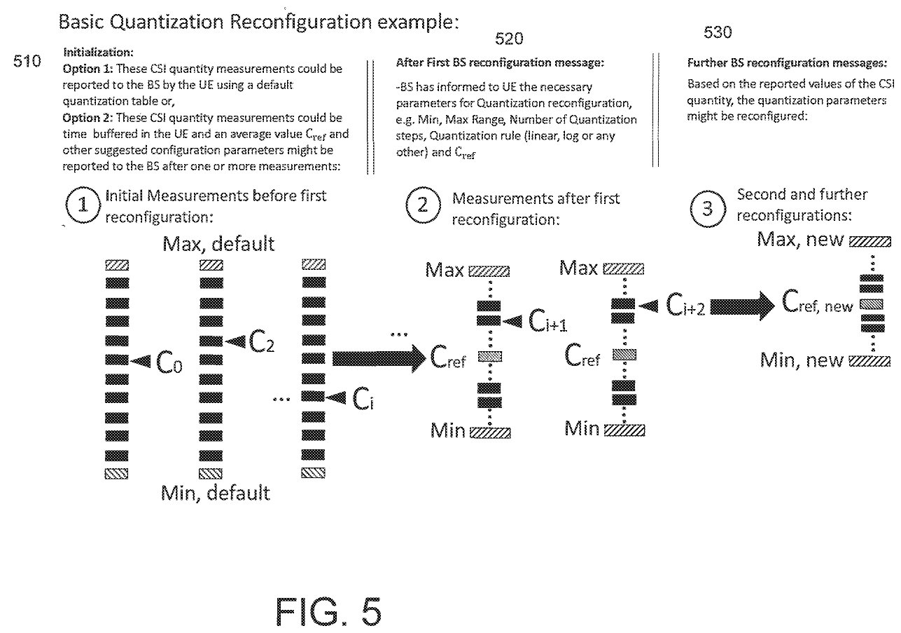

In an example embodiment, the quantization schemes for CSI quantities may be reconfigured. Referring now to FIG. 5, illustrated is a basic quantization reconfiguration example. A quantization scale with given Min, Max range, and C_{ref} variables, and the size of a selected set of quantization levels (i.e. the alphabet size), may be reconfigured across time. In a first stage (510) initial measurements may be made, before the first reconfiguration of the quantization table. The measurement and quantization of the CSI quantity may be initialized. This first stage may require that one or more measurements C₁, C₂, . . . , Cᵢ be made at/by the UE. In Option 1, the report of the initial measurements may be initially reported using a prefixed/default/initially configured quantization setup (e.g. a default quantization table), and each of the values may be reported to the BS for further decision making. Alternatively, in Option 2, the UE may buffer these measurements (e.g. over time) and, just after some knowledge has been accumulated, some statistical parameters may be reported to the BS. For example, an average value of the CSI quantity (i.e. C_{ref}), minimum and/or maximum value range, etc. may be reported after one or more measurements have already been made. It can be noted that the decision of the choice of quantization parameters can be influenced by more than one CSI quantity in a CSI report. For instance, PMI or CQI might influence the decision on the quantization parameters for TDCP. Moreover, the UE reported feedback of the CSI quantity is not a single source of information for the decision-making process discussed here. Prior knowledge inside the network (i.e. RAN) is also a valid source for this process. In this sense, prior knowledge means knowledge obtained by the network based on statistical measurements, historical data or knowledge of the measured process itself obtained from simulations and field tests. This data is useful to create a typical profile parametrization with respective quantization parameters for a given use case. Also, the combination of prior knowledge and UE report feedback is also a possibility to further enhance the reconfiguration.

Regarding the quantization maximum and/or minimum value range which define the neighboring region around the reference, such values do not require to be located exactly symmetrically with respect to C_{ref}. Even the minimum or maximum value edges may be fixed to a given value, without loss of generality. In addition, the UE may suggest a recommended number of quantization states, and also a quantization rule (e.g. linear, logarithmic, or any other). The number of suggested parameters by the UE or inferred by the BS may be quite diverse. For instance, for the case of a set of TDCP values, other parameters may also be defined during reconfiguration, such as number of reported amplitude and/or phase value(s), delay(s) between the measured TRS(s), etc.

After having defined the reporting and quantization parameters, the BS may send this configuration to the UE. For example, the BS may inform the UE of necessary parameters for quantization reconfiguration (e.g. min, max range, alphabet size, number of quantization levels, quantization rule (e.g. linear, log, etc.), C_{ref}). After having acknowledged the configuration, the UE may report the CSI quantity for some time using the already defined quantization parameters, as seen in the second stage (520), where the quantization after the first reconfiguration may be performed. At the same time, the UE and/or the BS may continue collecting historical statistics to be able to decide whether the current configuration is adequate, or may be optimized, as in the third stage (530). In other words, second and further reconfigurations may be performed based on further BS reconfiguration messages, which may be based on the reported values of the CSI quantity.

In the example of FIG. 5, C_{ref,new} may be calculated based on Cᵢ₊₁ . . . Cᵢ₊₂ or based on C₀ . . . Cᵢ₊₂. The length of the historical buffer may vary depending on specific implementation details. For example, the last X measurements may be used, or the full historical record since the start of measurement/reporting.

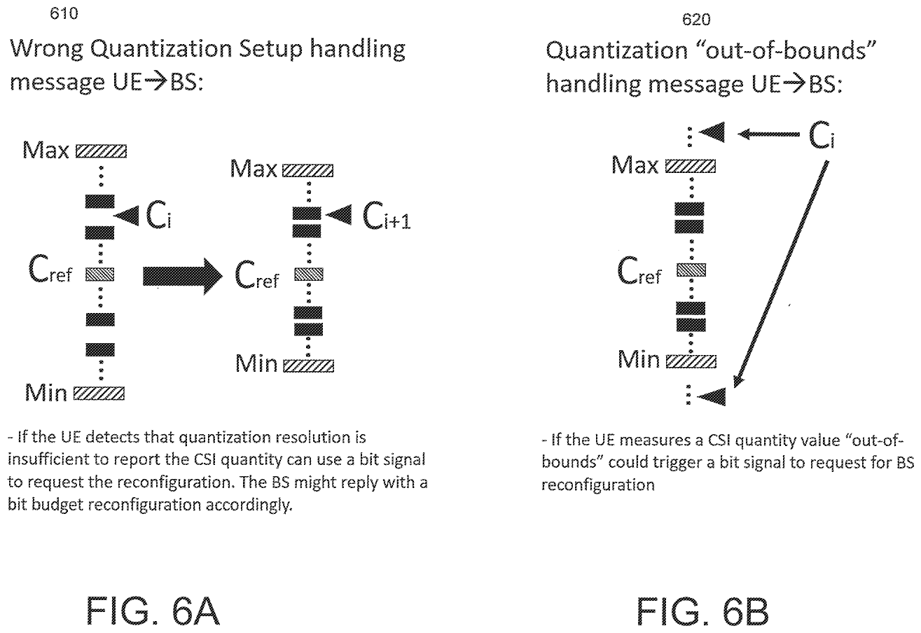

Referring now to FIGS. 6A and 6B, illustrated are some examples of control signaling messages that may be transmitted between the UE and the BS. The UE may report different types of bit signaling messages. For example, at 610, the UE may detect that the quantization resolution is not enough to properly quantize the CSI value, and may request for reconfiguration due to a wrong quantization setup. If the UE detects that the quantization resolution is insufficient to report the CSI quantity, the UE may use a bit signal to request the reconfiguration. The BS may reply with a bit budget reconfiguration accordingly. In another example, at 620, the UE may detect whether the measured CSI quantity is out of the bounds of the quantization scale. For example, if the UE measures a CSI quantity value outside the quantization range, the UE may transmit, to the BS, a bit signal to request for BS reconfiguration. In such a case, the BS may require increasing the quantization range. Depending on the bit budget allowed for quantization of the CSI quantity, a new reconfiguration may imply a trade-off with other quantization parameters.

In the real world, systems floating point numbers are rarely transmitted in control messages. This fact is not only the main reason for quantization of measurements, but also a problem when the NW wants to configure (in NR RRC for example) the UE with a C_{ref} value. C_{ref} may be a quantized value in a configuration message.

One way to configure the UE with the C_{ref} value, and adding the desired flexibility to a logarithmic quantizer similar to those used in Rel-16 Type-II amplitude quantization, is to configure C_{ref} indirectly by configuring the quantization parameters. By defining a size-Q bits quantization alphabet as {1−2^{-N-q/S}, q=0, 1, . . . , 2^{Q}−1} with N≥2^{Q}−1, the gNB may control the quantization levels by configuring one or more of the integer parameters (N, Q, S), where S controls the step-size, N controls the maximum number of quantization levels, Q controls the size of the quantization alphabet. So, (N, Q, S) together control the final quantization range, for example by selecting the 2^{Q} largest values of the quantization levels. For example, the step-size in dB is given by 20 log₁₀ 2⁻¹/S, i.e. 3 dB for S=2, 1.5 dB for S=4, 0.75 dB for S=8, etc. Note that for a fixed S, as N increases, the quantization levels become closer to 1, whereas for a fixed N, as S increases, the step-size decreases and the quantization levels move further away from 1. For example, for (N, S, Q)=(20, 2, 3), the quantizer alphabet becomes: {0.9990 0.9986 0.9980 0.9972 0.9961 0.9945 0.9922 0.9890}. FIG. 7 illustrates how this approach may work. Referring now to FIG. 7, illustrated is an example of a quantization configuration with parameters applied for a logarithmic quantization.

The previous embodiment may be extended by assuming that reference quantization level may be obtained by using the different from the final quantization alphabet step-size. For example, the size-Q bits quantization alphabet

$$\{ 1 - {2}^{\frac{N - i \cdot q}{S}} , q = 0 , 1 , … , {2}^{Q} - 1 \}$$

may be configured using parameters N, Q, S, and a new parameter i (a quantization step shift) that defines how many steps may be used to shift each quantization level. In other words, the first quantization level

$$1 - {2}^{- \frac{N}{S}}$$

may be the same as in previous embodiment, but step-size may be multiplied by i. By using this additional parameter, we may choose reference levels more precisely.

Another way to configure the UE with the C_{ref} value is from a quantization alphabet itself. For example, if the Rel-16 Type-II amplitude quantizer is used, one of the possible quantizer values may be used as a shifting reference for further measurements to be quantized. If p is a value in a quantization alphabet family

$$\{ 1 - {2}^{\frac{- q}{s}} , q = 0 , 1 , … , {2}^{Q} - 1 \} ,$$

where Q controls the size of the quantization alphabet and S controls the step-size, then C_{ref} may also be a member of this quantization alphabet. Further possible values may be shifted by C_{ref}, becoming members of

$$\{ {C}_{ref} - {2}^{\frac{- q}{s}} \} .$$

Notably, for C_{ref} calculation and for final quantization levels calculation, different members from the family

$$\{ x - {2}^{\frac{- q}{s}} \}$$

may be used (i.e. different ranges and values of q and s).

Another possible way to report a CSI quantity might be for instance to report the complement of the value. Thus, in the case of TDCP if we have 1−A(t, τ) and logarithmic quantization levels p(i) might be used instead of 1−p(i). In that case, we would need higher concentration of quantization levels near 0, and not near 1. For example,

$$\{ {2}^{\frac{- q}{s}} , q = 0 , 1 , … {2}^{Q} - 1 \}$$

$$instead of$$

$$\{ 1 - {2}^{\frac{- q}{s}} , q = 0 , 1 , … , {2}^{Q} - 1 \} .$$

Another way to indirectly configure the UE with the C_{ref} value, could be used if a default quantization alphabet is defined, for example

$$ℳ = \{ {2}^{\frac{- q}{{s}_{0}}} , q = 0 , 1 , … , {2}^{Q} - 1 \} ,$$

where Q defines the size of the quantization alphabet and S₀ defines the default step-size. If the network decides to (re) configure the quantization alphabet, it may do it by indicating to the UE at least one of the following alphabet transformation parameters: N, S, i. The parameterized quantization alphabet may be obtained by transforming the default alphabet:

$${ℳ}^{i \cdot {S}_{0} / S} \cdot {2}^{- N / S} = \{ {2}^{- \frac{N + i \cdot q}{S}} , q = 0 , 1 , … , {2}^{Q} - 1 \} ;$$

by this transformation, we may be changing the alphabet maximal quantization level, step-size, and quantization step shift. Unnecessary parts of the transformation may be removed. For example, if it is only needed to change step-size, the transformation may look like

$${ℳ}^{{S}_{0} / S} = \{ {2}^{- \frac{q}{S}} , q = 0 , 1 , … , {2}^{Q} - 1 \} ;$$

if it is needed only to change alphabet maximal quantization level, the transformation may look like:

$$ℳ \cdot {2}^{- N / {S}_{0}} = \{ {2}^{- \frac{N + \cdot q}{{S}_{0}}} , q = 0 , 1 , … , {2}^{Q} - 1 \} ;$$

if it is not needed to change quantization step shift, the transformation may look like:

$${ℳ}^{{S}_{0} / S} \cdot {2}^{- N / S} = \{ {2}^{- \frac{N + \cdot q}{S}} , q = 0 , 1 , … , {2}^{Q} - 1 \} .$$

Alternatively, transformation

$$1 - {ℳ}^{i \cdot {S}_{0} / S} \cdot {2}^{- N / S}$$

may be used if quantization levels should be concentrated near 1, and not near 0.

In example embodiments that do not use a reference value C_{ref} for configuration directly, the network may need to find an equivalent or closest to equivalent value in available quantization levels, for example from a family of quantization levels 2^{-N/S}, or if we want the reference to be in the middle of the alphabet, from family of quantization levels

$${2}^{- \frac{N - {}^{2 {}^{Q / 2}}}{S}} .$$

For example, we may find a closest to value −log₂(C_{ref}) ratio N/S, out of all the available N and S values. If we want to shift reference level to the middle of the alphabet, we may shift N by

$$\frac{{2}^{Q}}{2}$$

or another integer value between 1 and 2^{Q}, for example if N−2^{Q}/2 is smaller than 2^{Q}.

Another way to configure the UE with the C_{ref} value is as C_{ref}=1-10^{x/10}, where x is from, for example, {−15 dB, −13.5 dB, . . . , −6 dB, −4.5 dB}, such that the quantization levels are given by:

$$\{ {C}_{ref} - 1 {0}^{\frac{x}{10}} \} .$$

In an alternative example embodiment, the initial quantization configuration of the CSI value may be linear (uniform) from 0 to 1 with, for example, 8 levels, i.e., 3 bits reporting. When needed, the NW may send a reconfiguration message to the UE indicating the single reference value C_{ref}>0.5. The new quantization alphabet may be deduced as:

$$[ 2 {C}_{ref} - 1 , 2 \cdot {C}_{ref} - 1 + \frac{( 1 - {C}_{ref} )}{3} , 2 \cdot {C}_{ref} - 1 + \frac{2 \cdot ( 1 - {C}_{ref} )}{3} , … , 1 ] \qquad Eq 3$$

In this alternative example embodiment, the reconfiguration message may need to indicate to the UE only one value. If C_{ref}<0.5, then the quantization alphabet may be

$$[ 0 , \frac{{C}_{ref}}{3} , \frac{2 \cdot {C}_{ref}}{3} , … , 2 \cdot {C}_{ref} ] .$$

In another alternative example embodiment, the initial quantization configuration of the CSI value may be based on Rel-16 eType-II quantization with, for example, 16 levels, i.e., 4 bits reporting. Then, the initial quantization alphabet may look like this:

$$[ 0 , {( \frac{1}{2} )}^{\frac{15}{4}} , {( \frac{1}{2} )}^{\frac{14}{4}} , … , {( \frac{1}{2} )}^{\frac{1}{4}} , 1 ] .$$

When needed, the NW may send a reconfiguration message to the UE indicating a single reference value C_{ref}>0.5. The new quantization alphabet may be deduced as:

$$[ {C}_{ref} - 1 , {C}_{ref} - {( \frac{1}{2} )}^{\frac{1}{4}} , {C}_{ref} - {( \frac{1}{2} )}^{\frac{2}{4}} , … , {C}_{ref} - {( \frac{1}{2} )}^{\frac{15}{4}} , {C}_{ref} ] \qquad Eq 4$$

In this alternative example embodiment, the reconfiguration message may also need to indicate to the UE only one value.

In another alternative example embodiment, the initial quantization configuration of the CSI value may be based on the logarithmic scale 10·log₁₀(1−A) dB), where A is the measured TDCP value, with, for example, 8 levels i.e., 3 bits reporting. Then, the initial quantization alphabet may look like this: [−8, −7, −6, −5, −4, −3, −2, −1, 0]. When needed, the NW may send a reconfiguration message to the UE indicating a single reference value C_{ref}. The new quantization alphabet may be deduced as:

$$[ {C}_{ref} - 8 , {C}_{ref} - 7 , … , {C}_{ref} - 1 , {C}_{ref} ] \\ or , as \qquad Eq 5.1$$

$$[ {C}_{ref} - 8 , {C}_{ref} - 7 , … , {C}_{ref} - 1 , {C}_{ref} ] \qquad Eq 5.2$$

In this alternative example embodiment, the reconfiguration message may also need to indicate to the UE only one value. The reconfiguration may shift the alphabet to the values of importance.

In another alternative example embodiment, the initial quantization configuration of the CSI value may be based on the logarithmic scale 10·log₁₀(1−A) dB), where A is the measured TDCP value, with, for example, 8 levels i.e., 3 bits reporting. Then, the initial quantization alphabet may look like this: [−8, −7, −6, −5, −4, −3, −2, −1, 0]. When needed, the NW may send a reconfiguration message to the UE indicating single reference values C_{ref1} and C_{ref2}. The new quantization alphabet may be deduced as:

$$[ {C}_{ref 1} - 8 {C}_{ref 2} , {C}_{ref 1} - 7 {C}_{ref 2} , … , {C}_{ref 1} - {C}_{ref 2} , {C}_{ref 1} ] or , as \qquad Eq 6.1$$

$$[ {C}_{ref 1} - 4 {C}_{ref 2} , {C}_{ref 1} - 3 {C}_{ref 2} , {C}_{ref 1} - 2 {C}_{ref 2} , {C}_{ref 1} - {C}_{ref 2} , {C}_{ref 1} , {C}_{ref 1} + {C}_{ref 2} , {C}_{ref 1} + 2 {C}_{ref 2} , {C}_{ref 1} + 3 {C}_{ref 2} + {C}_{ref 1} + 4 {C}_{ref 2} ] \qquad Eq 6.2$$

In this alternative example embodiment, the reconfiguration message may need to indicate to the UE only two values. The reconfiguration may effectively shift the alphabet to the values of importance and change the step-size.

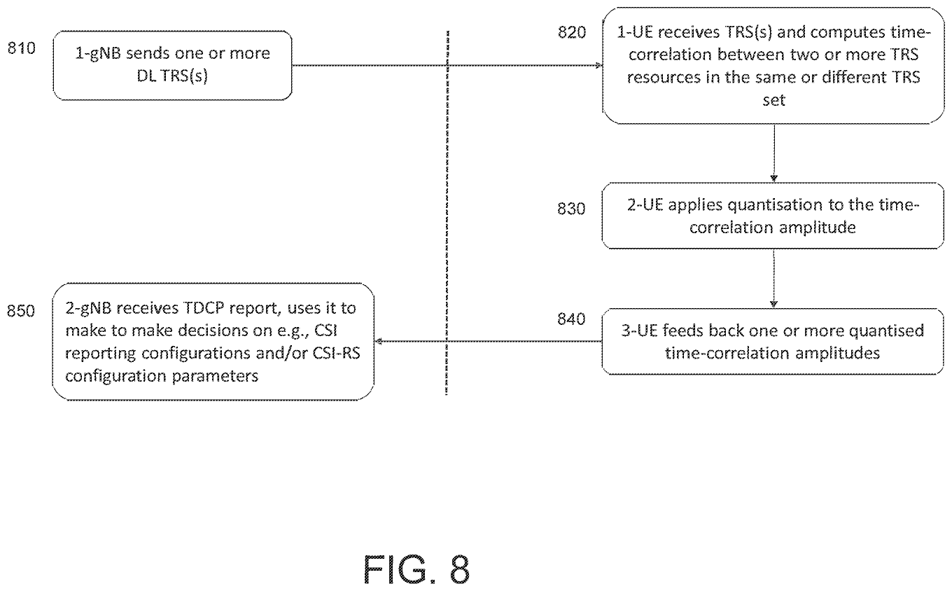

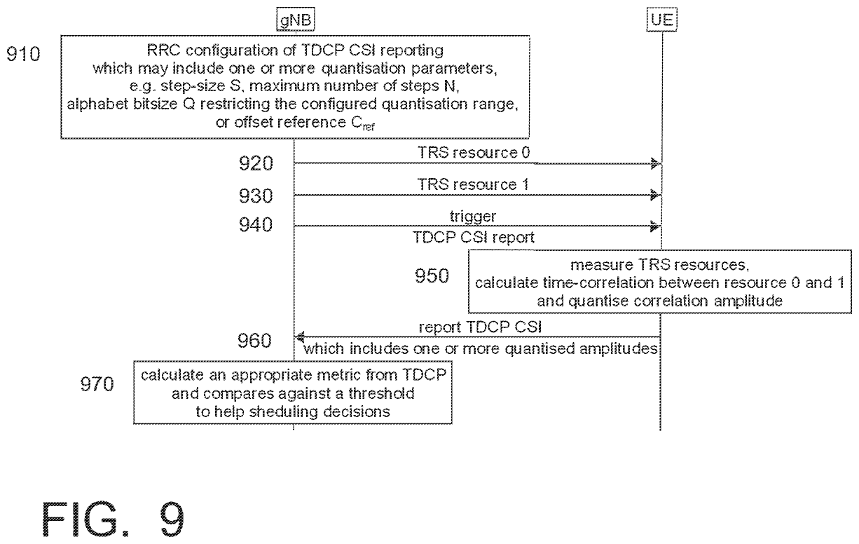

Referring now to FIG. 8, illustrated is an example of messaging between a gNB/base station and a UE. At 810, the gNB may send one or more DL TRS9s). At 820, the UE may receive the TRS(s) and may compute the time correlation between two or more TRS resources in the same or different TRS set. At 830, the UE may apply quantization to the time-correlation amplitude. At 840, the UE may transmit, to the gNB, one or more quantized time-correlation amplitudes. This may be considered the TDCP report. At 850, the gNB may receive the TDCP report, and may use it to make decisions on, for example, CSI reporting configuration(s) and/or CSI-RS configuration parameter(s).

Referring now to FIG. 9, illustrated is an example of signaling between a gNB/base station and a UE. At 910, the gNB may perform an RRC configuration of TDCP CSI reporting, which may include one or more quantization parameters, for example step-size S, maximum number of levels N, alphabet bitsize (also referred to as bitwidth) Q restricting the configured quantization alphabet, or offset reference C_{ref}. N may control the maximum number of levels and may, together with S, the maximum dynamic range, the alphabet bitsize Q, with N≥2^{Q}−1, restrict the configured dynamic range by selecting, for example, the 2^{Q} largest quantization levels as the quantization alphabet.

At 920, the gNB may transmit, to the UE, TRS resource 0. At 930, the gNB may transmit, to the UE, TRS resource 1. While in the example of FIG. 9 two TRS resources are transmitted to the UE, this is not limiting; any number of TRS resources may be transmitted to, and received at/with, the UE. At 940, the gNB may transmit, to the UE, a trigger for a TDCP CSI report. The report may be triggered by the network aperiodically. Optionally, the report may be triggered by some event detected at/by the UE.

At 950, the UE may measure TRS resources, calculate time-correlation between resource 0 and 1, and quantize the correlation amplitude. At 960, the UE may transmit, to the gNB, the TDCP CSI report. The report may include one or more quantized amplitudes. At 970, the gNB may calculate an appropriate metric from the TDCP report, and may compare this against a threshold. The result of this process may be used in making scheduling decisions.

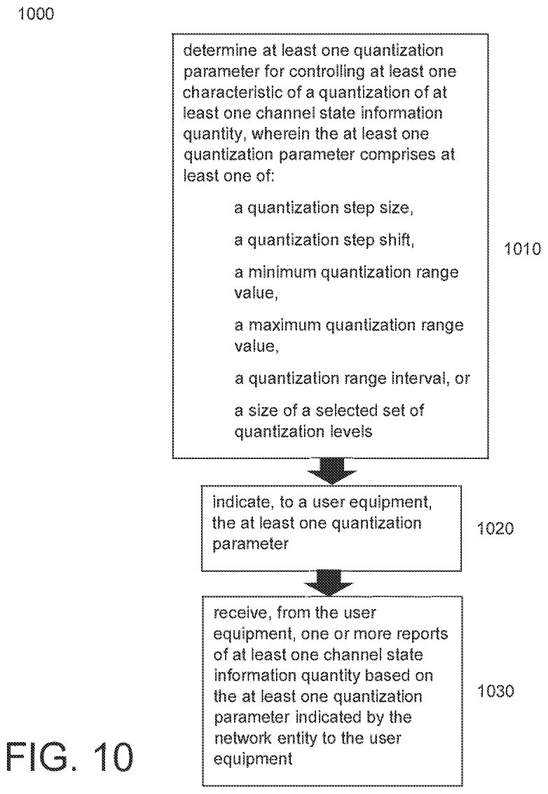

FIG. 10 illustrates the potential steps of an example method 1000. The example method 1000 may include: determining at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels, 1010; indicating, to a user equipment, the at least one quantization parameter, 1020; and receiving, from the user equipment, one or more reports of at least one channel state information quantity based on the at least one quantization parameter indicated by the network entity to the user equipment, 1030. The example method 1000 may be performed, for example, with a gNB, base station, eNB, network entity, etc. A network entity may, for example, correspond to a Base Station (BS), a Transmission point (TRP) or a set of these transmitting network devices.

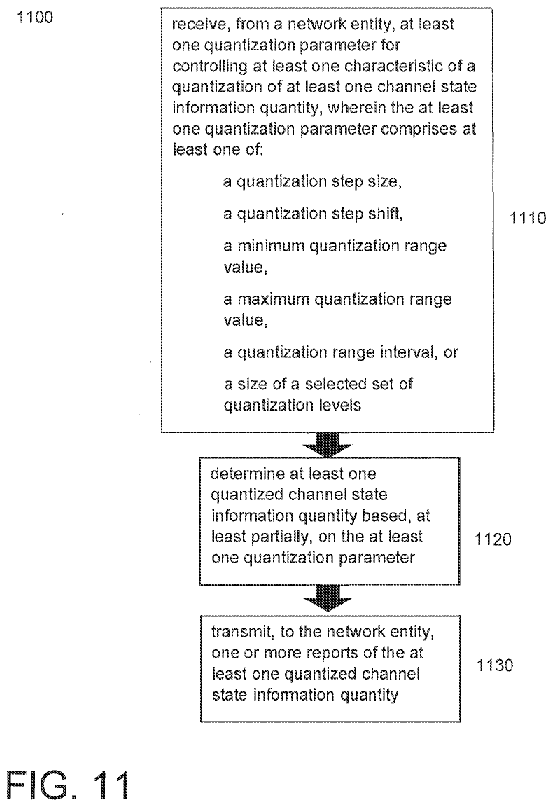

FIG. 11 illustrates the potential steps of an example method 1100. The example method 1100 may include: receiving, from a network entity, at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels, 1110; determining at least one quantized channel state information quantity based, at least partially, on the at least one quantization parameter, 1120; and transmitting, to the network entity, one or more reports of the at least one quantized channel state information quantity, 1130. The example method 1100 may be performed, for example, with a user equipment.

In accordance with one example embodiment, an apparatus may comprise: at least one processor; and at least one memory storing instructions that, when executed by the at least one processor, cause the apparatus at least to: determine at least one quantization parameter for controlling at least one characteristic of a quantization of at least one channel state information quantity, wherein the at least one quantization parameter may comprise at least one of: a quantization step size, a quantization step shift, a minimum quantization range value, a maximum quantization range value, a quantization range interval, or a size of a selected set of quantization levels; indicate, to a user equipment, the at least one quantization parameter; and receive, from the user equipment, one or more reports of at least one channel state information quantity based on the at least one quantization parameter indicated by the network entity to the user equipment.

The at least one quantization parameter may be determined based on prior knowledge, or the at least one quantization parameter may be determined based, at least partially, on one or more previously received reports. The example apparatus may be further configured to: transmit, to the user equipment, a reference offset parameter associated with the selected set of quantization levels, wherein the reference offset parameter may be for controlling the at least one characteristic of the quantization of the at least one channel state information quantity.

The at least one quantization parameter may be indicated via a channel state information report configuration.

In accordance with one aspect, an example method may be provided comprising: determining, with a network entity, at least one quantization parameter for controlling at least one characteristic of a quantization of at least one channel state information quantity, wherein the at least one quantization parameter may comprise at least one of: a quantization step size, a quantization step shift, a minimum quantization range value, a maximum quantization range value, a quantization range interval, or a size of a selected set of quantization levels; indicating, to a user equipment, the at least one quantization parameter; and receiving, from the user equipment, one or more reports of at least one channel state information quantity based on the at least one quantization parameter indicated by the network entity to the user equipment.

The at least one quantization parameter may be determined based on prior knowledge, or the at least one quantization parameter may be determined based, at least partially, on one or more previously received reports.

The example method may further comprise: transmitting, to the user equipment, a reference offset parameter associated with the selected set of quantization levels, wherein the reference offset parameter may be for controlling the at least one characteristic of the quantization of the at least one channel state information quantity.

The at least one quantization parameter may be indicated via a channel state information report configuration.

In accordance with one example embodiment, an apparatus may comprise: circuitry configured to perform: determining at least one quantization parameter for controlling at least one characteristic of a quantization of at least one channel state information quantity, wherein the at least one quantization parameter may comprise at least one of: a quantization step size, a quantization step shift, a minimum quantization range value, a maximum quantization range value, a quantization range interval, or a size of a selected set of quantization levels; circuitry configured to perform: indicating, to a user equipment, the at least one quantization parameter; and circuitry configured to perform: receiving, from the user equipment, one or more reports of at least one channel state information quantity based on the at least one quantization parameter indicated by the network entity to the user equipment.

In accordance with one example embodiment, an apparatus may comprise: processing circuitry; memory circuitry including computer program code, the memory circuitry and the computer program code configured to, with the processing circuitry, enable the apparatus to: determine at least one quantization parameter for controlling at least one characteristic of a quantization of at least one channel state information quantity, wherein the at least one quantization parameter may comprise at least one of: a quantization step size, a quantization step shift, a minimum quantization range value, a maximum quantization range value, a quantization range interval, or a size of a selected set of quantization levels; indicate, to a user equipment, the at least one quantization parameter; and receive, from the user equipment, one or more reports of at least one channel state information quantity based on the at least one quantization parameter indicated by the network entity to the user equipment.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: determining at least one quantization parameter for controlling at least one characteristic of a quantization of at least one channel state information quantity, wherein the at least one quantization parameter may comprise at least one of: a quantization step size, a quantization step shift, a minimum quantization range value, a maximum quantization range value, a quantization range interval, or a size of a selected set of quantization levels; indicating, to a user equipment, the at least one quantization parameter; and receiving, from the user equipment, one or more reports of at least one channel state information quantity based on the at least one quantization parameter indicated by the network entity to the user equipment.

The at least one quantization parameter may be determined based on prior knowledge, or the at least one quantization parameter may be determined based, at least partially, on one or more previously received reports.

The means may be further configured to perform: transmitting, to the user equipment, a reference offset parameter associated with the selected set of quantization levels, wherein the reference offset parameter may be for controlling the at least one characteristic of the quantization of the at least one channel state information quantity.

The at least one quantization parameter may be indicated via a channel state information report configuration.

The means may be further configured to perform: determining an initial configuration of the one or more quantization parameters for the user equipment; and providing, to the user equipment, the initial configuration.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: determine at least one quantization parameter for controlling at least one characteristic of a quantization of at least one channel state information quantity, wherein the at least one quantization parameter may comprise at least one of: a quantization step size, a quantization step shift, a minimum quantization range value, a maximum quantization range value, a quantization range interval, or a size of a selected set of quantization levels; cause indicating, to a user equipment, of the at least one quantization parameter; and cause receiving, from the user equipment, of one or more reports of at least one channel state information quantity based on the at least one quantization parameter indicated by the network entity to the user equipment.

In accordance with one example embodiment, a non-transitory computer-readable medium comprising program instructions stored thereon for performing at least the following: determining at least one quantization parameter for controlling at least one characteristic of a quantization of at least one channel state information quantity, wherein the at least one quantization parameter may comprise at least one of: a quantization step size, a quantization step shift, a minimum quantization range value, a maximum quantization range value, a quantization range interval, or a size of a selected set of quantization levels; causing indicating, to a user equipment, of the at least one quantization parameter; and causing receiving, from the user equipment, of one or more reports of at least one channel state information quantity based on the at least one quantization parameter indicated by the network entity to the user equipment.

In accordance with another example embodiment, a non-transitory program storage device readable by a machine may be provided, tangibly embodying instructions executable by the machine for performing operations, the operations comprising: determining at least one quantization parameter for controlling at least one characteristic of a quantization of at least one channel state information quantity, wherein the at least one quantization parameter may comprise at least one of: a quantization step size, a quantization step shift, a minimum quantization range value, a maximum quantization range value, a quantization range interval, or a size of a selected set of quantization levels; causing indicating, to a user equipment, of the at least one quantization parameter; and causing receiving, from the user equipment, of one or more reports of at least one channel state information quantity based on the at least one quantization parameter indicated by the network entity to the user equipment.

In accordance with another example embodiment, a non-transitory computer-readable medium comprising instructions that, when executed by an apparatus, cause the apparatus to perform at least the following: determining at least one quantization parameter for controlling at least one characteristic of a quantization of at least one channel state information quantity, wherein the at least one quantization parameter may comprise at least one of: a quantization step size, a quantization step shift, a minimum quantization range value, a maximum quantization range value, a quantization range interval, or a size of a selected set of quantization levels; causing indicating, to a user equipment, of the at least one quantization parameter; and causing receiving, from the user equipment, of one or more reports of at least one channel state information quantity based on the at least one quantization parameter indicated by the network entity to the user equipment.

A computer implemented system comprising: at least one processor and at least one non-transitory memory storing instructions that, when executed by the at least one processor, cause the system at least to perform: determining at least one quantization parameter for controlling at least one characteristic of a quantization of at least one channel state information quantity, wherein the at least one quantization parameter may comprise at least one of: a quantization step size, a quantization step shift, a minimum quantization range value, a maximum quantization range value, a quantization range interval, or a size of a selected set of quantization levels; causing indicating, to a user equipment, of the at least one quantization parameter; and causing receiving, from the user equipment, of one or more reports of at least one channel state information quantity based on the at least one quantization parameter indicated by the network entity to the user equipment.

A computer implemented system comprising: means for determining at least one quantization parameter for controlling at least one characteristic of a quantization of at least one channel state information quantity, wherein the at least one quantization parameter may comprise at least one of: a quantization step size, a quantization step shift, a minimum quantization range value, a maximum quantization range value, a quantization range interval, or a size of a selected set of quantization levels; means for causing indicating, to a user equipment, of the at least one quantization parameter; and means for causing receiving, from the user equipment, of one or more reports of at least one channel state information quantity based on the at least one quantization parameter indicated by the network entity to the user equipment.

In accordance with one example embodiment, an apparatus may comprise: at least one processor; and at least one memory storing instructions that, when executed by the at least one processor, cause the apparatus at least to: receive, from a network entity, at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determine at least one quantized channel state information quantity based, at least partially, on the at least one quantization parameter; and transmit, to the network entity, one or more reports of the at least one quantized channel state information quantity.

The at least one quantization parameter may be received via a channel state information report configuration.

Determining the at least one quantized channel state information quantity may comprise the example apparatus being further configured to: determine a time domain correlation between two or more channel state information reference signals.

Determining the at least one quantized channel state information quantity may comprise the example apparatus being further configured to: determine a set of quantization levels based, at least partially, on at least one of the at least one quantization parameter.

Determining the at least one quantized channel state information quantity may comprise the example apparatus being further configured to: quantize an amplitude of at least one time correlation function coefficient obtained from the two or more channel state information reference signals using the determined set of quantization levels.

The example apparatus may be further configured to: receive a reference offset parameter associated with the selected set of quantization levels, wherein the reference offset parameter may be for controlling the at least one characteristic of the quantization of the at least one channel state information quantity.

The example apparatus may be further configured to: transmit, to the network entity, a recommended value for the at least one quantization parameter or for at least one reference offset parameter.

The one or more reports may comprise at least one of: an average value of the at least one channel state information quantity, a minimum value of a range for the at least one channel state information quantity, or a maximum value of a range for the at least one channel state information quantity.

The example apparatus may be further configured to: transmit, to the network entity, a request for a channel state information report configuration.

In accordance with one aspect, an example method may be provided comprising: receiving, with a user equipment from a network entity, at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determining at least one quantized channel state information quantity based, at least partially, on the at least one quantization parameter; and transmitting, to the network entity, one or more reports of the at least one quantized channel state information quantity.

The at least one quantization parameter may be received via a channel state information report configuration.

The determining of the at least one quantized channel state information quantity may comprise: determining a time domain correlation between two or more channel state information reference signals.

The determining of the at least one quantized channel state information quantity may further comprise: determining a set of quantization levels based, at least partially, on at least one of the at least one quantization parameter.

The determining of the at least one quantized channel state information quantity may further comprise: quantizing an amplitude of at least one time correlation function coefficient obtained from the two or more channel state information reference signals using the determined set of quantization levels.

The example method may further comprise: receiving a reference offset parameter associated with the selected set of quantization levels, wherein the reference offset parameter may be for controlling the at least one characteristic of the quantization of the at least one channel state information quantity.

The example method may further comprise: transmitting, to the network entity, a recommended value for the at least one quantization parameter or for at least one reference offset parameter.

The one or more reports may comprise at least one of: an average value of the at least one channel state information quantity, a minimum value of a range for the at least one channel state information quantity, or a maximum value of a range for the at least one channel state information quantity.

The example method may further comprise: transmitting, to the network entity, a request for a channel state information report configuration.

In accordance with one example embodiment, an apparatus may comprise: circuitry configured to perform: receiving, from a network entity, at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; circuitry configured to perform: determining at least one quantized channel state information quantity based, at least partially, on the at least one quantization parameter; and circuitry configured to perform: transmitting, to the network entity, one or more reports of the at least one quantized channel state information quantity.

In accordance with one example embodiment, an apparatus may comprise: processing circuitry; memory circuitry including computer program code, the memory circuitry and the computer program code configured to, with the processing circuitry, enable the apparatus to: receive, from a network entity, at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determine at least one quantized channel state information quantity based, at least partially, on the at least one quantization parameter; and transmit, to the network entity, one or more reports of the at least one quantized channel state information quantity.

In accordance with one example embodiment, an apparatus may comprise means for performing: receiving, from a network entity, at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determining at least one quantized channel state information quantity based, at least partially, on the at least one quantization parameter; and transmitting, to the network entity, one or more reports of the at least one quantized channel state information quantity.

The at least one quantization parameter may be received via a channel state information report configuration.

The means configured to perform determining the at least one quantized channel state information quantity may comprise means configured to perform: determining a time domain correlation between two or more channel state information reference signals.

The means configured to perform determining the at least one quantized channel state information quantity may further comprise means configured to perform: determining a set of quantization levels based, at least partially, on at least one of the at least one quantization parameter.

The means configured to perform determining the at least one quantized channel state information quantity may further comprise means configured to perform: quantizing an amplitude of at least one time correlation function coefficient obtained from the two or more channel state information reference signals using the determined set of quantization levels.

The means may be further configured to perform: receiving a reference offset parameter associated with the selected set of quantization levels, wherein the reference offset parameter may be for controlling the at least one characteristic of the quantization of the at least one channel state information quantity.

The means may be further configured to perform: transmit, to the network entity, a recommended value for the at least one quantization parameter or for at least one reference offset parameter.

The one or more reports may comprise at least one of: an average value of the at least one channel state information quantity, a minimum value of a range for the at least one channel state information quantity, or a maximum value of a range for the at least one channel state information quantity.

The means may be further configured to perform: transmitting, to the network entity, a request for a channel state information report configuration.

In accordance with one example embodiment, a non-transitory computer-readable medium comprising instructions stored thereon which, when executed with at least one processor, cause the at least one processor to: cause receiving, from a network entity, of at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determine at least one quantized channel state information quantity based, at least partially, on the at least one quantization parameter; and cause transmitting, to the network entity, of one or more reports of the at least one quantized channel state information quantity.

In accordance with one example embodiment, a non-transitory computer-readable medium comprising program instructions stored thereon for performing at least the following: causing receiving, from a network entity, of at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determining at least one quantized channel state information quantity based, at least partially, on the at least one quantization parameter; and causing transmitting, to the network entity, of one or more reports of the at least one quantized channel state information quantity.

In accordance with another example embodiment, a non-transitory program storage device readable by a machine may be provided, tangibly embodying instructions executable by the machine for performing operations, the operations comprising: causing receiving, from a network entity, of at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determining at least one quantized channel state information quantity based, at least partially, on the at least one quantization parameter; and causing transmitting, to the network entity, of one or more reports of the at least one quantized channel state information quantity.

In accordance with another example embodiment, a non-transitory computer-readable medium comprising instructions that, when executed by an apparatus, cause the apparatus to perform at least the following: causing receiving, from a network entity, of at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determining at least one quantized channel state information quantity based, at least partially, on the at least one quantization parameter; and causing transmitting, to the network entity, of one or more reports of the at least one quantized channel state information quantity.

A computer implemented system comprising: at least one processor and at least one non-transitory memory storing instructions that, when executed by the at least one processor, cause the system at least to perform: causing receiving, from a network entity, of at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; determining at least one quantized channel state information quantity based, at least partially, on the at least one quantization parameter; and causing transmitting, to the network entity, of one or more reports of the at least one quantized channel state information quantity.

A computer implemented system comprising: means for causing receiving, from a network entity, of at least one quantization parameter for controlling at least one characteristic of a quantization of at least one channel state information quantity, wherein the at least one quantization parameter comprises at least one of: a quantization step size, a quantization step shift, a minimum quantization range value, a maximum quantization range value, a quantization range interval, or a size of a selected set of quantization levels; means for determining at least one quantized channel state information quantity based, at least partially, on the at least one quantization parameter; and means for causing transmitting, to the network entity, of one or more reports of the at least one quantized channel state information quantity.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

What is claimed is:

1. An apparatus, comprising:
at least one processor; and
at least one non-transitory memory storing instructions that, when executed by the at least one processor, cause the apparatus at least to:
determine at least one quantization parameter for controlling at least one characteristic of a quantization of at least one channel state information quantity, wherein the at least one quantization parameter comprises at least one of:
a quantization step size,
a quantization step shift,
a minimum quantization range value,
a maximum quantization range value,
a quantization range interval, or
a size of a selected set of quantization levels;
indicate, to a user equipment, the at least one quantization parameter; and
receive, from the user equipment, one or more reports of at least one channel state information quantity based on the at least one quantization parameter indicated by the apparatus to the user equipment.

2. The apparatus of claim 1, wherein:
the at least one quantization parameter is determined based on prior knowledge, or
the at least one quantization parameter is determined based, at least partially, on one or more previously received reports.

3. The apparatus of claim 1, wherein the at least one memory stores instructions that, when executed by the at least one processor, cause the apparatus to:
transmit, to the user equipment, a reference offset parameter associated with the selected set of quantization levels, wherein the reference offset parameter is for controlling the at least one characteristic of the quantization of the at least one channel state information quantity.

4. The apparatus of claim 1, wherein the at least one quantization parameter is indicated via a channel state information report configuration.

5. An apparatus, comprising:
at least one processor; and
at least one non-transitory memory storing instructions that, when executed by the at least one processor, cause the apparatus at least to:
receive, from a network entity, at least one quantization parameter for controlling at least one characteristic of a quantization of at least one channel state information quantity, wherein the at least one quantization parameter comprises at least one of:
a quantization step size,
a quantization step shift,
a minimum quantization range value,
a maximum quantization range value,
a quantization range interval, or
a size of a selected set of quantization levels;
determine at least one quantized channel state information quantity based, at least partially, on the at least one quantization parameter; and
transmit, to the network entity, one or more reports of the at least one quantized channel state information quantity.

6. The apparatus of claim 5, wherein the at least one quantization parameter is received via a channel state information report configuration.

7. The apparatus of claim 5, wherein determining the at least one quantized channel state information quantity comprises the at least one memory stores instructions that, when executed by the at least one processor, cause the apparatus to:
determine a time domain correlation between two or more channel state information reference signals.

8. The apparatus of claim 7, wherein determining the at least one quantized channel state information quantity further comprises the at least one memory stores instructions that, when executed by the at least one processor, cause the apparatus to:
determine a set of quantization levels based, at least partially, on at least one of the at least one quantization parameter.

9. The apparatus of claim 8, wherein determining the at least one quantized channel state information quantity further comprises the at least one memory stores instructions that, when executed by the at least one processor, cause the apparatus to:
quantize an amplitude of at least one time correlation function coefficient obtained from the two or more channel state information reference signals using the determined set of quantization levels.

10. The apparatus of claim 5, wherein the at least one memory stores instructions that, when executed by the at least one processor, cause the apparatus to:
receive a reference offset parameter associated with the selected set of quantization levels, wherein the reference offset parameter is for controlling the at least one characteristic of the quantization of the at least one channel state information quantity.

11. The apparatus of claim 5, wherein the at least one memory stores instructions that, when executed by the at least one processor, cause the apparatus to:
transmit, to the network entity, a recommended value for the at least one quantization parameter or for at least one reference offset parameter.

12. The apparatus of claim 5, wherein the one or more reports comprise at least one of:
an average value of the at least one channel state information quantity,
a minimum value of a range for the at least one channel state information quantity, or
a maximum value of a range for the at least one channel state information quantity.

13. The apparatus of claim 5, wherein the at least one memory stores instructions that, when executed by the at least one processor, cause the apparatus to:
transmit, to the network entity, a request for a channel state information report configuration.

14. A method, comprising:
receiving, with a user equipment from a network entity, at least one quantization parameter for controlling at least one characteristic of a quantization of at least one channel state information quantity, wherein the at least one quantization parameter comprises at least one of:
a quantization step size,
a quantization step shift,
a minimum quantization range value,
a maximum quantization range value,
a quantization range interval, or
a size of a selected set of quantization levels;
determining at least one quantized channel state information quantity based, at least partially, on the at least one quantization parameter; and
transmitting, to the network entity, one or more reports of the at least one quantized channel state information quantity.

15. The method of claim 14, wherein the at least one quantization parameter is received via a channel state information report configuration.

16. The method of claim 14, wherein the determining of the at least one quantized channel state information quantity comprises:
determining a time domain correlation between two or more channel state information reference signals.

17. The method of claim 16, wherein the determining of the at least one quantized channel state information quantity further comprises:
determining a set of quantization levels based, at least partially, on at least one of the at least one quantization parameter.

18. The method of claim 17, wherein the determining of the at least one quantized channel state information quantity further comprises:
quantizing an amplitude of at least one time correlation function coefficient obtained from the two or more channel state information reference signals using the determined set of quantization levels.

19. The method of claim 14, further comprising:
receiving a reference offset parameter associated with the selected set of quantization levels, wherein the reference offset parameter is for controlling the at least one characteristic of the quantization of the at least one channel state information quantity.

20. The method of claim 14, further comprising:
transmitting, to the network entity, a recommended value for the at least one quantization parameter or for at least one reference offset parameter.
